(19) United States
(12) Patent Application Publication
(10) Pub. No.: US 2015/0350847 A1
(43) Pub. Date: Dec. 3, 2015

(54) PHONE BASED CONTEXT ENGINE FOR POSITIONING

(71) Applicant: QUALCOMM Incorporated, San Diego, CA (US)

(72) Inventors: Hui CHAO, San Jose, CA (US); Jiajian CHEN, San Jose, CA (US); Saumitra Mohan DAS, Santa Clara, CA (US)

(73) Assignee: QUALCOMM Incorporated, San Diego, CA (US)

(21) Appl. No.: 14/291,454

(22) Filed: May 30, 2014

(51) Int. Cl. H04W 4/04; H04W 4/02

(52) U.S. Cl. CPC H04W 4/04; H04W 4/021

(57) ABSTRACT

Disclosed are methods and apparatuses for improving location estimation. The method receives LCI updates from an LCI disambiguation engine. The method determines that a trigger threshold is reached, wherein the trigger threshold is based on proximity to a poor location estimation region. The method requests enhanced assistance data, wherein the assistance data includes at least one AP associated with a second LCI that is different than a first LCI, the first LCI being associated with a present position of the apparatus. The method receives position updates from a Position Engine using the enhanced assistance data.

### BACKGROUND OF THE INVENTION

1. Field of the Invention

The disclosure is directed to improving location estimation.

2. Description of the Related Art

Modern GIS technologies use digital information, for which various digitized data creation methods are used. GIS accuracy depends upon source data, and how it is encoded to be data referenced. A wireless local area network (WLAN)-based positioning technique is a typical method for resolving the difficulties of the foregoing indoor positioning, which calculates the location of a terminal by using a reference location of a WLAN access point (AP) and a measurement signal. The WLAN-based positioning technique is divided into a method for acquiring a reference position of an AP, and a method for determining the location of a terminal by using the acquired reference location of the AP and a measurement signal. The method for acquiring the reference location of the AP includes a method for using the location of an AP voluntarily registered by a user through a certain device and a method for calculating the location of an AP by a limited provider by processing measurement information collected through a planned path by using a dedicated device, and the like.

Dilution of precision (DOP) refers to the additional multiplicative effect of navigation geometry on positional measurement precision. The effect of geometry of the APs on position error is called geometric dilution of precision and it is roughly interpreted as ratio of position error to the range error. For example, a square pyramid can be formed by the linear distance from four separate APs to the receiver, with the receiver at the tip of the pyramid. The larger the volume of the pyramid, the better (lower) the value of DOP; the smaller its volume, the worse (higher) the value of DOP will be.

The horizontal dilution of precision, H DOP=\sqrt{νₓ²+σ_{y}²}, is dependent on the coordinate system used. To correspond to the local horizon plane, x and y can denote positions in either a north, east coordinate system or a south, east coordinate system.

### SUMMARY

The disclosure is directed to selecting an access point (AP) associated with a different Location Context Identifier (LCI) to improve location estimation in locations where poor location estimation may result in low estimation quality.

An apparatus within a mobile station can comprise a processor, coupled to a memory. The processor can be configured to receive location context identifier (LCI) updates from an LCI disambiguation engine; determine that a trigger threshold is reached, wherein the trigger threshold is based on proximity to a poor location estimation region; request enhanced assistance data, wherein the assistance data includes at least one access point (AP) associated with a second LCI that is different than a first LCI, the first LCI being associated with a present position of the apparatus; and receive position updates from a Position Engine using the enhanced assistance data.

A method can improve location estimation. The method can receive LCI updates from an LCI disambiguation engine. The method can determine whether a trigger threshold is reached, wherein the trigger threshold can be based on proximity to a poor location estimation region. The method can request enhanced assistance data, wherein the assistance data includes at least one AP associated with a second LCI that is different than a first LCI, the first LCI being associated with a present position of the apparatus. The method can receive position updates from a Position Engine using the enhanced assistance data.

A non-transitory computer-readable storage medium can comprise instructions, which, when executed by an apparatus in a wireless communications system, cause the apparatus to perform operations to improve location estimation. The non-transitory computer-readable storage medium can comprise code for receiving LCI updates from an LCI disambiguation engine. The non-transitory computer-readable storage medium can comprise code for determining that a trigger threshold is reached, wherein the trigger threshold can be based on proximity to a poor location estimation region. The non-transitory computer-readable storage medium can comprise code for requesting enhanced assistance data, wherein the assistance data can include at least one AP associated with a second LCI that is different than a first LCI, the first LCI being associated with a present position of the apparatus. The non-transitory computer-readable storage medium can comprise code for receiving position updates from a Position Engine using the enhanced assistance data.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure, and in which:

FIG. 1 illustrates an exemplary operating environment for a mobile station that can improve location techniques, according to one aspect of the disclosure.

FIG. 2 illustrates an exemplary mobile station that may be used in an operating environment that can improve location techniques, according to one aspect of the disclosure.

FIG. 3 illustrates an operational flow of a method to improve location techniques, according to one aspect of the disclosure.

FIG. 4 illustrates a communication device that includes logic configured to improve location techniques, according to one aspect of the disclosure.

FIG. 5 illustrates an exemplary server to improve location techniques, according to one aspect of the disclosure.

FIG. 6 illustrates an environment in which improving location techniques can be used by selecting the shortest distance to an AP, according to one aspect of the disclosure.

FIG. 7 illustrates an environment in which improving location techniques can be used by determining coverage in another LCI, according to one aspect of the disclosure.

FIG. 8 illustrates an environment in which improving location techniques can be used by predicting which APs in another floor will improve the coverage in the current floor using a full heatmap model, according to one aspect of the disclosure.

### DETAILED DESCRIPTION

Various aspects are disclosed in the following description and related drawings. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

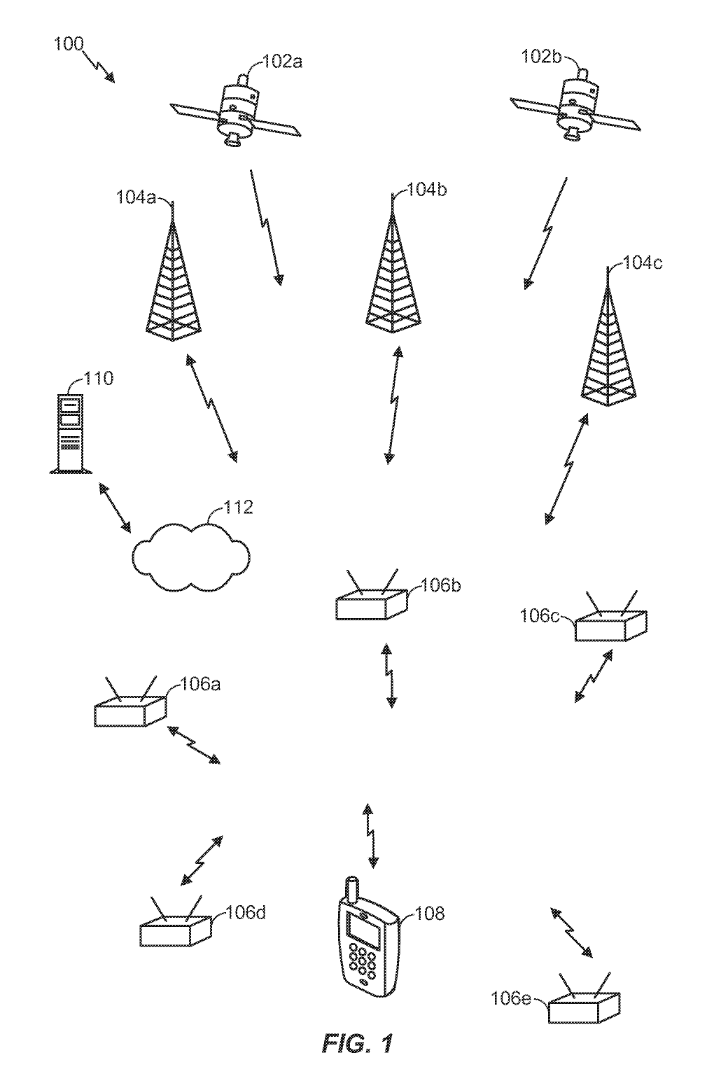

According to one aspect of the disclosure, FIG. 1 illustrates an exemplary operating environment 100 for a mobile station 108 having wireless positioning capability. Embodiments are directed to a mobile station 108 which may determine its position based upon round trip time (RTT) measurements that are adjusted to accommodate for processing delays introduced by wireless access points. The processing delays may vary among different access points and may also change over time. By using information from a motion sensor, the mobile station 108 may calibrate out the effects of the processing delays introduced by the wireless access points.

The operating environment 100 may contain one or more different types of wireless communication systems and/or wireless positioning systems. In the embodiment shown in FIG. 1, a Satellite Positioning System (SPS) 102a-b may be used as an independent source of position information for the mobile station 108. The mobile station 108 may include one or more dedicated SPS receivers specifically designed to receive signals for deriving geo location information from the SPS satellites.

The operating environment 100 may also include one or more Wide Area Network Wireless Access Points (WAN-WAPs) 104a-c, which may be used for wireless voice and/or data communication, and as another source of independent position information for the mobile station 108. The WAN-WAPs 104a-c may be part of a wide area wireless network (WWAN), which may include cellular base stations at known locations, and/or other wide area wireless systems, such as, for example, WiMAX (e.g., 802.16). The WWAN may include other known network components which are not shown in FIG. 1 for simplicity. Typically, each of the WAN-WAPs 104a-c within the WWAN may operate from fixed positions, and provide network coverage over large metropolitan and/or regional areas.

The operating environment 100 may further include one or more Local Area Network Wireless Access Points (LAN-WAPs) 106a-e, which may be used for wireless voice and/or data communication, as well as another independent source of position data. The LAN WAPs can be part of a Wireless Local Area Network (WLAN), which may operate in buildings and perform communications over smaller geographic regions than a WWAN. Such LAN-WAPs 106a-e may be part of, for example, WLAN networks (802.11x), cellular piconets and/or femtocells, Bluetooth Networks, etc.

The mobile station 108 may derive position information from any one or more of the SPS satellites 102a-b, the WAN-WAPs 104a-c, and/or the LAN-WAPs 106a-e. Each of the aforementioned systems can provide an independent estimate of a last location for the mobile station 108 using different techniques. In some embodiments, the mobile station 108 may combine the solutions derived from each of the different types of access points to improve the accuracy of the position data. When deriving position using the SPS 102a-b, the mobile station 108 may utilize a receiver specifically designed for use with the SPS that extracts position, using conventional techniques, from a plurality of signals transmitted by SPS satellites 102a-b.

A satellite positioning system (SPS) typically includes a system of transmitters positioned to enable entities to determine their location on or above the Earth based, at least in part, on signals received from the transmitters. Such a transmitter typically transmits a signal marked with a repeating pseudo-random noise (PN) code of a set number of chips and may be located on ground-based control stations, user equipment and/or space vehicles. In a particular example, such transmitters may be located on Earth orbiting satellite vehicles (SVs). For example, a SV in a constellation of Global Navigation Satellite System (GNSS) such as Global Positioning System (GPS), Galileo, Glonass or Compass may transmit a signal marked with a PN code that is distinguishable from PN codes transmitted by other SVs in the constellation (e.g., using different PN codes for each satellite as in GPS or using the same code on different frequencies as in Glonass). In accordance with certain aspects, the techniques presented herein are not restricted to global systems (e.g., GNSS) for SPS. For example, the techniques provided herein may be applied to or otherwise enabled for use in various regional systems, such as, e.g., Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS.

Furthermore, the disclosed method and apparatus may be used with positioning determination systems that utilize pseudolites or a combination of satellites and pseudolites. Pseudolites are ground-based transmitters that broadcast a PN code or other ranging code (similar to a GPS or CDMA cellular signal) modulated on an L-band (or other frequency) carrier signal, which may be synchronized with GPS time. Each such transmitter may be assigned a unique PN code so as to permit identification by a remote receiver. Pseudolites are useful in situations where GPS signals from an orbiting satellite might be unavailable, such as in tunnels, mines, buildings, urban canyons or other enclosed areas. Another implementation of pseudolites is known as radio-beacons. The term “satellite”, as used herein, is intended to include pseudolites, equivalents of pseudolites, and possibly others. The term “SPS signals,” as used herein, is intended to include SPS-like signals from pseudolites or equivalents of pseudolites.

When deriving position from the WWAN, each WAN-WAPs 104a-c may take the form of base stations within a digital cellular network, and the mobile station 108 may include a cellular transceiver and processor that can exploit the base station signals to derive position. Such cellular networks may include, but are not limited to, standards in accordance with GSM, CMDA, 2G, 3G, 4G, LTE, etc. It should be understood that digital cellular network may include additional base stations or other resources that may not be shown in FIG. 1. While WAN-WAPs 104a-c may actually be moveable or otherwise capable of being relocated, for illustration purposes it will be assumed that they are essentially arranged in a fixed position.

The mobile station 108 may perform position determination using known time of arrival (TOA) techniques such as, for example, Advanced Forward Link Trilateration (AFLT). In other embodiments, each WAN-WAP 104a-c may comprise a Worldwide Interoperability for Microwave Access (WiMAX) wireless networking base station. In this case, the mobile station 108 may determine its position using TOA techniques from signals provided by the WAN-WAPs 104a-c. The mobile station 108 may determine positions either in a stand-alone mode, or using the assistance of a positioning server 110 and network 112 using TOA techniques, as will be described in more detail below. Furthermore, various embodiments may have the mobile station 108 determine position information using WAN-WAPs 104a-c, which may have different types. For example, some WAN-WAPs 104a-c may be cellular base stations, and other WAN-WAPs 104a-c may be WiMAX base stations. In such an operating environment 100, the mobile station 108 may be able to exploit the signals from each different type of WAN-WAP 104a-c, and further combine the derived position solutions to improve accuracy.

When deriving position using the WLAN, the mobile station 108 may utilize time of arrival techniques with the assistance of the positioning server 110 and the network 112. The positioning server 110 may communicate to the mobile station 108 through network 112. Network 112 may include a combination of wired and wireless networks which incorporate the LAN-WAPs 106a-e. In one embodiment, each LAN-WAP 106a-e may be, for example, a WLAN wireless access point, which is not necessarily set in a fixed position and can change location. The position of each LAN-WAP 106a-e may be stored in the positioning server 110 in a common coordinate system. In one embodiment, the position of the mobile station 108 may be determined by having the mobile station 108 receive signals from each LAN-WAP 106a-e. Each signal may be associated with its originating LAN-WAP 106a-e based upon some form of identifying information that may be included in the received signal (such as, for example, a MAC address). The mobile station 108 may then sort the received signals based upon signal strength, and derive the time delays associated with each of the sorted received signals. The mobile station 108 may then form a message which can include the time delays and the identifying information of each of the LAN-WAPs 106a-e, and send the message via network 112 to the positioning sever 110. Based upon the received message, the positioning server may then determine a position, using the stored locations of the relevant LAN-WAPs 106a-e, of the mobile station 108. The positioning server 110 may generate and provide a Location Context Identifier (LCI) message to the mobile station 108 that includes a pointer to the position of the mobile station 108 in a local coordinate system. The LCI message may also include other points of interest in relation to the location of the mobile station 108. When computing the position of the mobile station 108, the positioning server may take into account the different delays which can be introduced by elements within the wireless network.

The position determination techniques described herein may be used for various wireless communication networks such as a wide area wireless network (WWAN), a wireless local area network (WLAN), a wireless personal area network (WPAN), and so on. The term “network” and “system” may be used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) and so on. A CDMA network may implement one or more radio access technologies (RATs) such as cdma2000, Wideband-CDMA (W-CDMA), and so on. cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be used for any combination of WWAN, WLAN and/or WPAN.

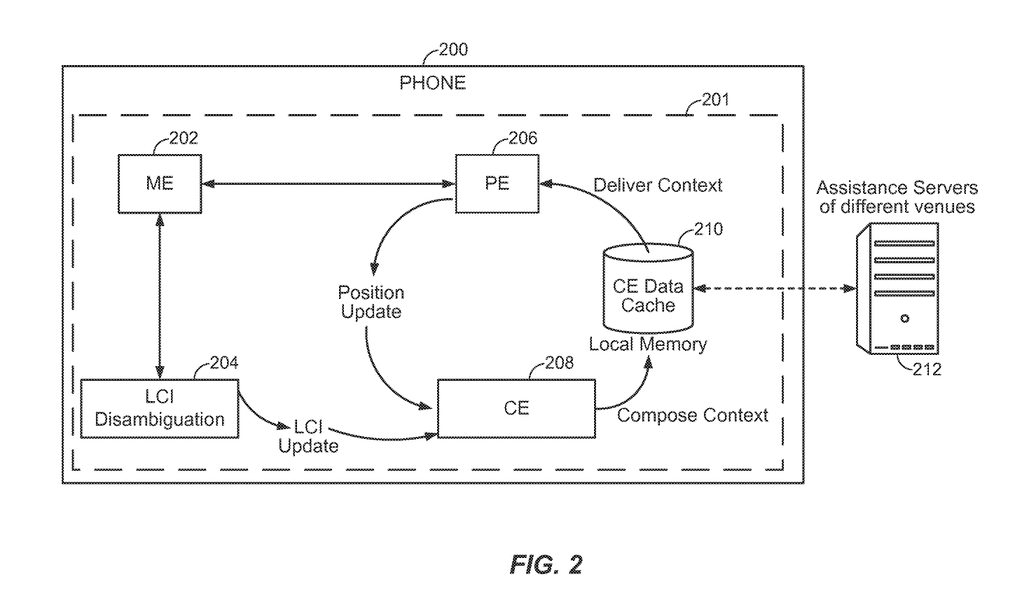

FIG. 2 illustrates a mobile station for improving location techniques, according to one aspect of the disclosure. The mobile station 200, shown as a mobile phone, comprises a mobility engine (ME) 202, a Location Context Identifier (LCI) disambiguation engine 204, a Position Engine (PE) 206, a Context Engine (CE) 208, and a CE data cache 210. In FIG. 2, a number of software modules and data tables are shown as residing in memory 201. The mobile station 200 can also communicate with outside sources, such as a server 212. As shown, the LCI disambiguation engine 204 provides LCI update information to the CE 208. The PE 206 also provides position update information to the CE 208. The CE 208 generates context data and stores it in the CE data cache 210. This data cache 210 can be accessed by the PE 206 and the server 212. The ME 202 can be in communication with the LCI disambiguation engine 204 and the PE 206.

In some embodiments, the context is defined as assistance data for a relevant region. The context data can consist of a single LCI with its access terminals or access points (APs) and associated data such as RSSI or RTT heatmap. The CE 208 can also compose assistance data file from multiple LCIs dynamically. In some embodiments, the CE 208 can use APs from multiple nearby LCIs for positioning within an LCI, for example, the LCI the mobile station is currently estimated to be located within.

A processor (not shown) may include any form of logic suitable for performing at least the techniques provided herein. For example, the processor may be operatively configurable based on instructions in the memory 201 to selectively initiate one or more routines that exploit motion data for use in other portions of the mobile station 200. One should appreciate that the organization of the memory contents as shown in FIG. 2 is merely exemplary, and as such the functionality of the modules and/or data structures may be combined, separated, and/or be structured in different ways depending upon the implementation of the mobile station 200.

While the modules shown in FIG. 2 are illustrated in the example as being contained in the memory 201, it is recognized that in certain implementations such procedures may be provided for or otherwise operatively arranged using other or additional mechanisms. For example, all or part of the wireless-based positioning ME 202 and/or the PE 206 may be provided in firmware. Additionally, while in this example the ME 202 and/or the PE 206 are illustrated as being separate features, it is recognized, for example, that such procedures may be combined together as one procedure or perhaps with other procedures, or otherwise further divided into a plurality of sub-procedures. In some embodiments, the modules can be in separate physical components. For example, the LCI disambiguation engine 204 can be located on the server 212 or the mobile station 200. The PE 206 can be located on the server 212 or the mobile station 200. For example, if the PE 206 is located on the server 212, the PE 206 can use network based positioning (NBP). Similarly, if the PE 206 is located on the mobile station 200, the PE 206 can use mobile based positioning (MBP).

As used herein, the mobile station 108 and/or mobile station 200 may be any portable or movable device or machine that is configurable to acquire wireless signals transmitted from, and transmit wireless signals to, one or more wireless communication devices or networks. As shown in FIG. 1 and FIG. 2, the mobile station 108 and/or mobile station 200 is representative of such a portable wireless device. Thus, by way of example but not limitation, the mobile station 108 may include a radio device, a cellular telephone device, a computing device, a personal communication system (PCS) device, or other like movable wireless communication equipped device, appliance, or machine. The term “mobile station” is also intended to include devices which communicate with a personal navigation device (PND), such as by short-range wireless, infrared, wire line connection, or other connection—regardless of whether satellite signal reception, assistance data reception, and/or position-related processing occurs at the device or at the PND. Also, “mobile station” is intended to include all devices, including wireless devices, computers, laptops, etc. which are capable of communication with a server, such as via the Internet, WLAN, or other network, and regardless of whether satellite signal reception, assistance data reception, and/or position-related processing occurs at the device, at a server, or at another device associated with the network. Any operable combination of the above is also considered a “mobile station.”

As used herein, the term “wireless device” may refer to any type of wireless communication device which may transfer information over a network and also have position determination and/or navigation functionality. The wireless device may be any cellular mobile terminal, personal communication system (PCS) device, personal navigation device, laptop, personal digital assistant, or any other suitable mobile station capable of receiving and processing network and/or SPS signals.

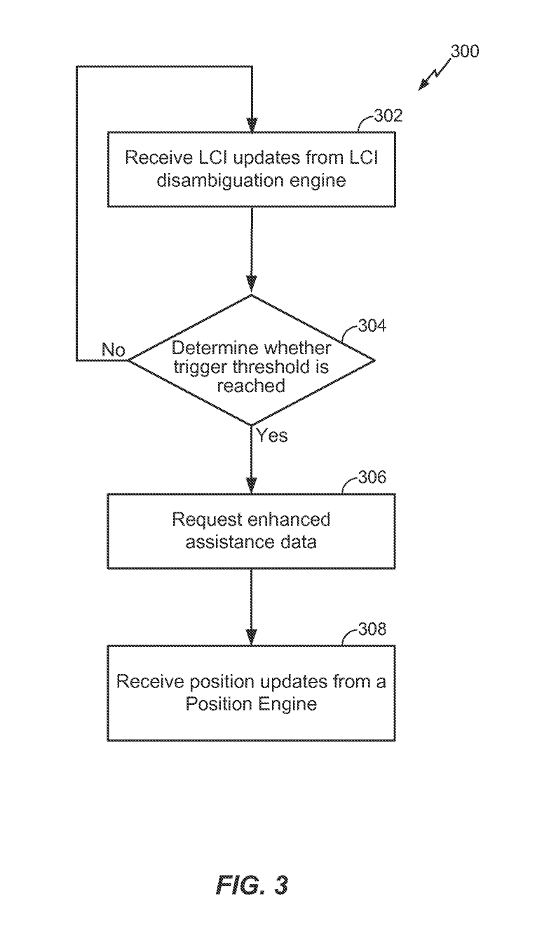

As illustrated in FIG. 3, an embodiment can include a method for improving location estimation, comprising: receiving LCI updates from an LCI disambiguation engine—Block 302; determining that a trigger threshold is reached, wherein the trigger threshold is based on proximity to a poor location estimation region—Block 304; requesting enhanced assistance data, wherein the assistance data includes at least one AP associated with a second LCI that is different than a first LCI, the first LCI being associated with a present position of the apparatus—Block 306; and receiving position updates from a Position Engine using the enhanced assistance data—Block 308.

In some embodiments, the at least one AP can be selected based on contribution of the at least one AP on improved location estimation at the present position of the apparatus.

In some embodiments, the received position updates can be generated at least in part using a cross floor heatmap model. The heatmap model can provide data regarding signal loss from an AP due to a floor that separates the AP from a mobile station. The heatmap model can provide data regarding constant cross-floor attenuation. The heatmap model can provide data regarding signal loss from the mobile station to the floor that separates the AP from a mobile station.

In some embodiments, an estimated location of the apparatus is based on at least one of GPS location or WiFi-based positioning. For example, the at least one AP can be determined by a distance from the at least one AP to a poor location estimation region. In some examples, the distance from the at least one AP to the poor location estimation region can be a function of three dimensional Euclidean distance. D can be calculated such that f(d_{3D}, d_{routable}, n_{wall}). In some examples, the at least one AP can be ranked based on its average distance to a grid point in the poor location estimation region.

In some embodiments, the method can also determine whether a Horizontal Dilution of Precision (HDOP) threshold has been reached; and request enhanced assistance data from a third AP if the HDOP threshold has not been met. For example, the HDOP threshold can be 1.5. For example, if the HDOP threshold is not met using four APs, the method can request data from a fifth AP and determine whether the HDOP threshold requirement has been met.

In some embodiments, a HDOP can be calculated using unit vectors of at least one AP. For a grid point located at (x,y), its HDOP value can be calculated as following, assuming AP, is located at (xᵢ,yᵢ). Ri is the distance between APᵢ and (x,y). As shown below, A is a matrix calculated below:

$$A = [ \begin{matrix}\frac{( {x}_{1} - x )}{{R}_{1}} & \frac{( {y}_{1} - y )}{{R}_{1}} & \frac{( {z}_{1} - z )}{{R}_{1}} & - 1 \\ \frac{( {x}_{2} - x )}{{R}_{2}} & \frac{( {2}_{1} - y )}{{R}_{2}} & \frac{( {z}_{2} - z )}{{R}_{2}} & - 1 \\ \frac{( {x}_{3} - x )}{{R}_{3}} & \frac{( {y}_{3} - y )}{{R}_{3}} & \frac{( {z}_{3} - z )}{{R}_{3}} & - 1 \\ \frac{( {x}_{4} - x )}{{R}_{4}} & \frac{( {y}_{4} - y )}{{R}_{4}} & \frac{( {z}_{4} - z )}{{R}_{4}} & - 1\end{matrix} ]$$

Q is a second matrix that can be calculated using values from A:

$$Q = {( {A}^{T} A )}^{- 1} = [ \begin{matrix}{σ}_{x}^{2} & {σ}_{xy} & {σ}_{xz} & {σ}_{xt} \\ {σ}_{xy} & {σ}_{y}^{2} & {σ}_{yz} & {σ}_{yt} \\ {σ}_{xz} & {σ}_{yz} & {σ}_{z}^{2} & {σ}_{zt} \\ {σ}_{xt} & {σ}_{yt} & {σ}_{zt} & {σ}_{t}^{2}\end{matrix} ]$$

Once the Q matrix is calculated, the HDOP can be calculated as H DOP=\sqrt{νₓ²+σ_{y}²}

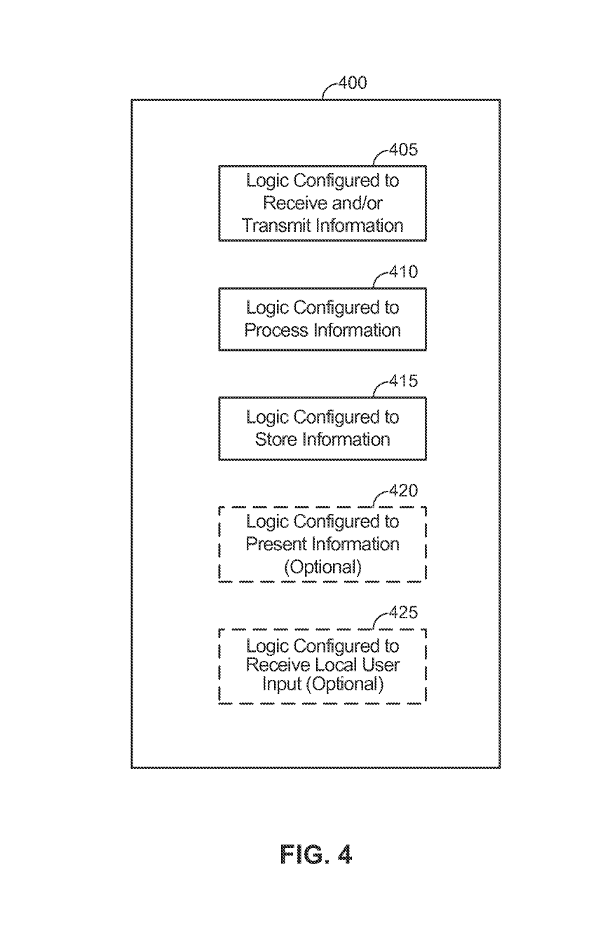

FIG. 4 illustrates an apparatus, shown as communication device 400 that includes logic configured to perform functionality. The communication device 400 can correspond to any of the above-noted communication devices, including but not limited to mobile station 108, mobile station 200, any components coupled to the network 112 (e.g., the server 110), and so on. Thus, communication device 400 can correspond to any electronic device that is configured to communicate with (or facilitate communication with) one or more other entities over the operating environment 100.

Referring to FIG. 4, the communication device 400 includes logic configured to receive and/or transmit information 405. In an example, if the communication device 400 corresponds to a wireless communications device (e.g., mobile station 200), the logic configured to receive and/or transmit information 405 can include a wireless communications interface (e.g., Bluetooth, Wi-Fi, Wi-Fi Direct, Long-Term Evolution (LTE) Direct, etc.) such as a wireless transceiver and associated hardware (e.g., an RF antenna, a MODEM, a modulator and/or demodulator, etc.). In another example, the logic configured to receive and/or transmit information 405 can correspond to a wired communications interface (e.g., a serial connection, a USB or Firewire connection, an Ethernet connection through which the network 112 can be accessed, etc.). Thus, if the communication device 400 corresponds to some type of network-based server (e.g., the positioning server 110), the logic configured to receive and/or transmit information 405 can correspond to an Ethernet card, in an example, that connects the network-based server to other communication entities via an Ethernet protocol. In a further example, the logic configured to receive and/or transmit information 405 can include sensory or measurement hardware by which the communication device 400 can monitor its local environment (e.g., an accelerometer, a temperature sensor, a light sensor, an antenna for monitoring local RF signals, etc.). The logic configured to receive and/or transmit information 405 can also include software that, when executed, permits the associated hardware of the logic configured to receive and/or transmit information 405 to perform its reception and/or transmission function(s). However, the logic configured to receive and/or transmit information 405 does not correspond to software alone, and the logic configured to receive and/or transmit information 405 relies at least in part upon hardware to achieve its functionality.

Referring to FIG. 4, the communication device 400 further includes logic configured to process information 410. In an example, the logic configured to process information 410 can include at least a processor. Example implementations of the type of processing that can be performed by the logic configured to process information 410 includes but is not limited to performing determinations, establishing connections, making selections between different information options, performing evaluations related to data, interacting with sensors coupled to the communication device 400 to perform measurement operations, converting information from one format to another (e.g., between different protocols such as .wmv to .avi, etc.), and so on. For example, the processor included in the logic configured to process information 410 can correspond to a general purpose processor, a DSP, an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration). The logic configured to process information 410 can also include software that, when executed, permits the associated hardware of the logic configured to process information 410 to perform its processing function(s). However, the logic configured to process information 410 does not correspond to software alone, and the logic configured to process information 410 relies at least in part upon hardware to achieve its functionality.

Referring to FIG. 4, the communication device 400 further includes logic configured to store information 415. In an example, the logic configured to store information 415 can include at least a non-transitory computer-readable storage medium (e.g., memory) and associated hardware (e.g., a memory controller, etc.). For example, non-transitory memory included in the logic configured to store information 415 can correspond to RAM, flash memory, ROM, erasable programmable ROM (EPROM), EEPROM, registers, hard disk, a removable disk, a CD-ROM, or any other form of storage medium known in the art. The logic configured to store information 415 can also include software that, when executed, permits the associated hardware of the logic configured to store information 415 to perform its storage function(s). However, the logic configured to store information 415 does not correspond to software alone, and the logic configured to store information 415 relies at least in part upon hardware to achieve its functionality.

Referring to FIG. 4, the communication device 400 further optionally includes logic configured to present information 420. In an example, the logic configured to present information 420 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communication device 400. For example, if the communication device 400 corresponds to the mobile station 200 as shown in FIG. 2, the logic configured to present information 420 can include the display 256. In a further example, the logic configured to present information 420 can be omitted for certain communication devices, such as network communication devices that do not have a local user (e.g., network switches or routers, remote servers, etc.). The logic configured to present information 420 can also include software that, when executed, permits the associated hardware of the logic configured to present information 420 to perform its presentation function(s). However, the logic configured to present information 420 does not correspond to software alone, and the logic configured to present information 420 relies at least in part upon hardware to achieve its functionality.

Referring to FIG. 4, the communication device 400 further optionally includes logic configured to receive local user input 425. In an example, the logic configured to receive local user input 425 can include at least a user input device and associated hardware. For example, the user input device can include buttons, a touchscreen display, a keyboard, a camera, an audio input device (e.g., a microphone or a port that can carry audio information such as a microphone jack, etc.), and/or any other device by which information can be received from a user or operator of the communication device 400. In one example, the logic configured to receive local user input 425 can be omitted for certain communication devices, such as network communication devices that do not have a local user (e.g., network switches or routers, remote servers, etc.). The logic configured to receive local user input 425 can also include software that, when executed, permits the associated hardware of the logic configured to receive local user input 425 to perform its input reception function(s). However, the logic configured to receive local user input 425 does not correspond to software alone, and the logic configured to receive local user input 425 relies at least in part upon hardware to achieve its functionality.

Referring to FIG. 4, while the configured logics of 405 through 425 are shown as separate or distinct blocks in FIG. 4, it will be appreciated that the hardware and/or software by which the respective configured logic performs its functionality can overlap in part. For example, any software used to facilitate the functionality of the configured logics of 405 through 425 can be stored in the non-transitory memory associated with the logic configured to store information 415, such that the configured logics of 405 through 425 each performs their functionality (i.e., in this case, software execution) based in part upon the operation of software stored by the logic configured to store information 415. Likewise, hardware that is directly associated with one of the configured logics can be borrowed or used by other configured logics from time to time. For example, the processor of the logic configured to process information 410 can format data into an appropriate format before being transmitted by the logic configured to receive and/or transmit information 405, such that the logic configured to receive and/or transmit information 405 performs its functionality (i.e., in this case, transmission of data) based in part upon the operation of hardware (i.e., the processor) associated with the logic configured to process information 410.

Generally, unless stated otherwise explicitly, the phrase “logic configured to” as used throughout this disclosure is intended to invoke an aspect that is at least partially implemented with hardware, and is not intended to map to software-only implementations that are independent of hardware. Also, it will be appreciated that the configured logic or “logic configured to” in the various blocks are not limited to specific logic gates or elements, but generally refer to the ability to perform the functionality described herein (either via hardware or a combination of hardware and software). Thus, the configured logics or “logic configured to” as illustrated in the various blocks are not necessarily implemented as logic gates or logic elements despite sharing the word “logic.” Other interactions or cooperation between the logic in the various blocks will become clear to one of ordinary skill in the art from a review of the aspects described below in more detail.

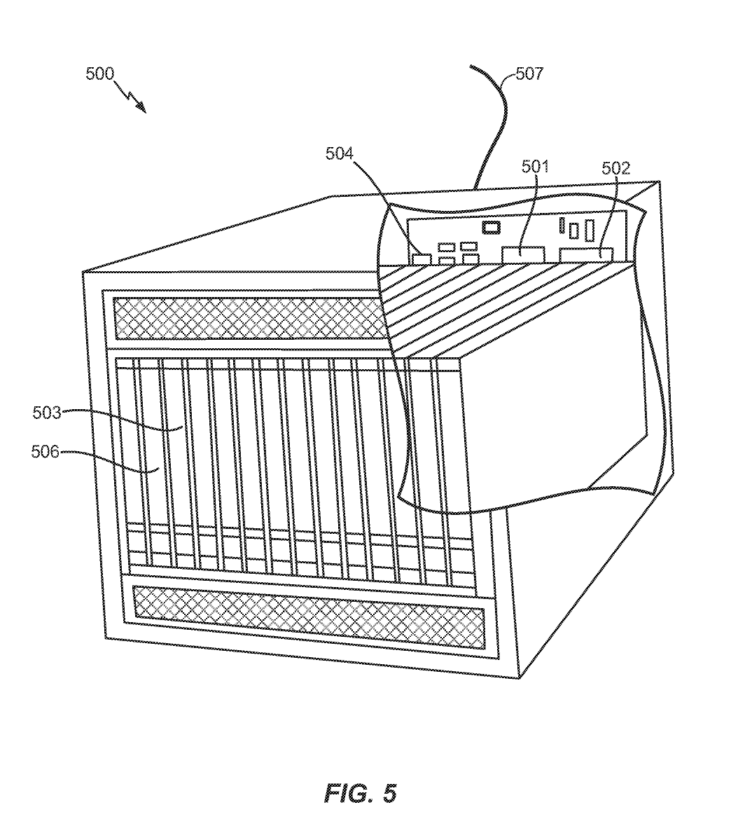

The various embodiments may be implemented on more than one apparatus, such as any of a variety of commercially available server devices, e.g., server 500 illustrated in FIG. 5. In an example, the server 500 may correspond to one example configuration of the positioning server 110 described above. In FIG. 5, the server 500 includes a processor 501 coupled to volatile memory 502 and a large capacity nonvolatile memory, such as a disk drive 503. The server 500 may also include a floppy disc drive, compact disc (CD) or DVD disc drive 506 coupled to the processor 501. The server 500 may also include network access ports 504 coupled to the processor 501 for establishing data connections with a network 507, such as a local area network coupled to other broadcast system computers and servers or to the Internet. In context with FIG. 4, it will be appreciated that the server 500 of FIG. 5 illustrates one example implementation of the communication device 400, whereby the logic configured to transmit and/or receive information 405 corresponds to the network access ports 504 used by the server 500 to communicate with the network 507, the logic configured to process information 410 corresponds to the processor 501, and the logic configuration to store information 415 corresponds to any combination of the volatile memory 502, the disk drive 503 and/or the disc drive 506. The optional logic configured to present information 420 and the optional logic configured to receive local user input 425 are not shown explicitly in FIG. 5 and may or may not be included therein. Thus, FIG. 5 helps to demonstrate that the communication device 400 may be implemented as a server, in addition to a mobile station 200 implementation as in FIG. 2.

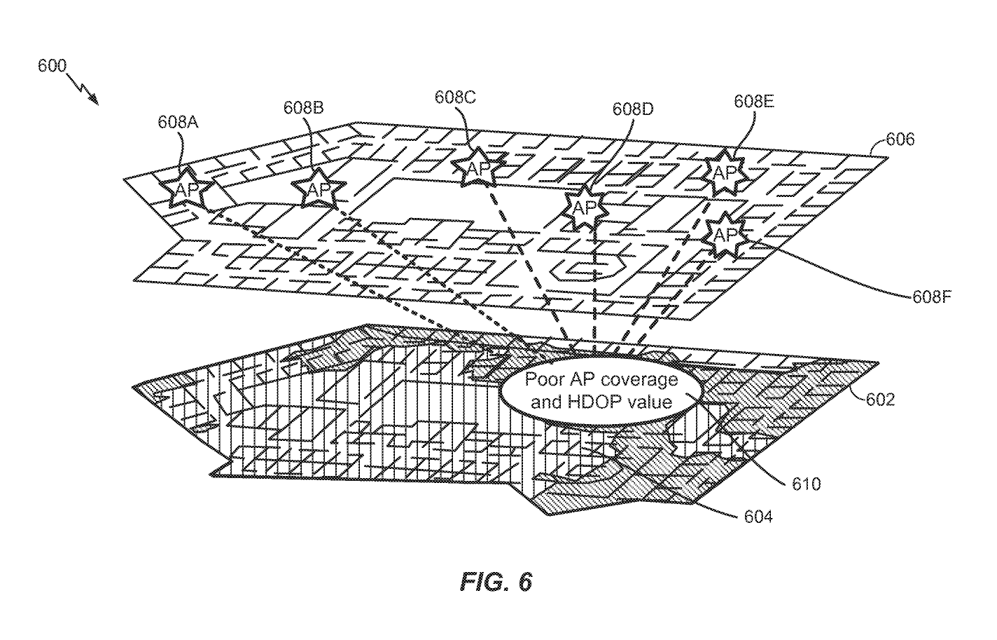

FIG. 6 illustrates an environment 600 in which improving location techniques can be used by selecting the shortest distance to an AP, according to one aspect of the disclosure. The environment 600 in FIG. 6 provides two floors. A first floor 602 is shown as having a location 604 with poor coverage and HDOP value. A second floor 606 is shown as having six APs 608A-F. In some embodiments, APs can be searched on different floors to find the shortest distance to a grid point in a poor coverage location. For example, location 604 comprises grid point 610. To determine which of the six APs 608A-F may be most desirable to improve location techniques, the distance between the grid point 610 and the APs 608A-F can be calculated. In some embodiments, the calculation can be determined using a three dimensional Euclidean distance function, or the routable distance between two points. For example, AP 608A's distance can be calculated such that f(d_{3D}, d_{routable}, n_{wall}). Once distances for all six APs 608A-F are calculated, their average distances to all grid points can be ranked in ascending order. In some embodiments, top ranked APs are selected, e.g., APs 608D-F.

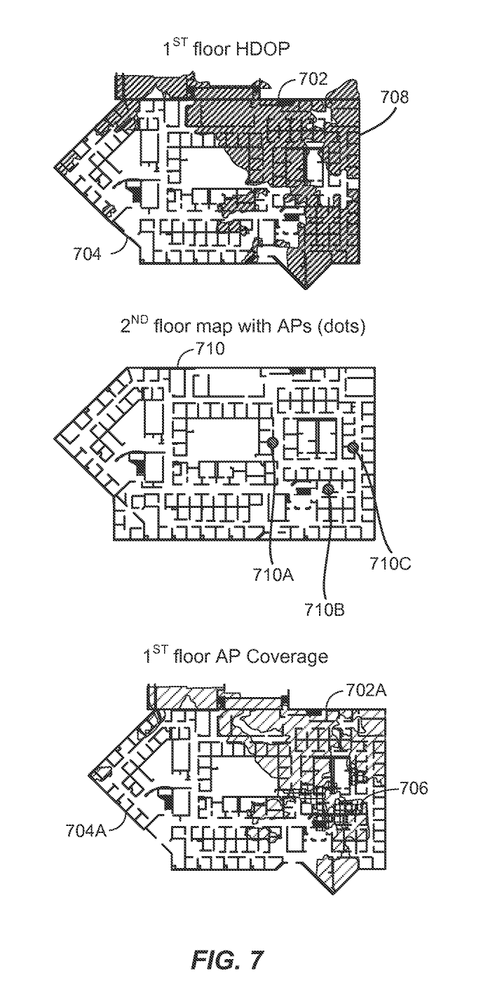

FIG. 7 illustrates an environment in which improving location techniques can be used by determining coverage in another LCI, according to one aspect of the disclosure. As shown, there are two floors, each with known coverage and assigned trigger thresholds based on HDOP. As shown in an HDOP map 702 of the first floor and an AP coverage map 702A of the first floor, some of the locations that are in the same floor have different HDOP levels. The HDOP map 702 shows areas with coverage above an HDOP threshold and below the threshold to determine if coverage is good in that location. In FIG. 7, a hatched area 708 has bad coverage and a white area 704 has good coverage.

In some embodiments, an AP on a second floor which corresponds to a poor coverage location 708 on the first floor can be used in AP selection. On the second floor map 710, there are APs 710A, 710B, and 710C. For example, as shown in AP coverage map 702A, gridded areas 706 have additional coverage from the APs 710A-C. In some embodiments, an AP on a separate floor may not be directly above the poor coverage location 708. For example, the APs 710A-C are not directly below the poor coverage location 708, but may still be useful in improving position for the first floor.

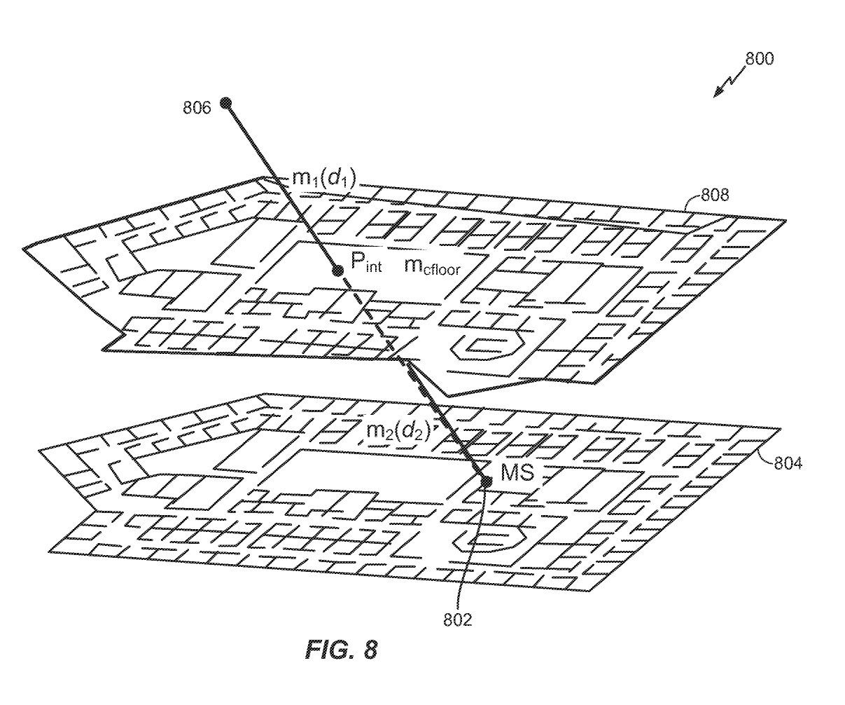

FIG. 8 illustrates an environment in which improving location techniques can be used by predicting which APs in another floor will improve the coverage in the current floor using a full heatmap model, according to one aspect of the disclosure. In some embodiments, a heatmap model can be used to provide signal strength information that is more accurate using an understanding of the effects of physical barriers such as walls and floors. As shown in FIG. 8, the heatmap model 800 shows two floors. A mobile station 802 is on the first floor 804. An AP 806 is on a second floor 808, positioned above the first floor 804.

In some embodiments, the heatmap model 800 can comprise information regarding the flooring to assist in determining signal attenuation. The heatmap model can provide data regarding signal loss from the AP 806 to the second floor 808 that separates the AP 806 from a mobile station 802. For example, the distance between AP 806 and the flooring of the second floor 808 is d₁. The heatmap model can provide data regarding signal loss from the mobile station 802 to the second floor 808 that separates the AP 806 from the mobile station 802. The distance between the flooring of the second floor 808 to the mobile station 802 is d_{z}. The signal loss for d₁ can be represented as m₁(d₁), and the signal loss for d₂ can be represented as m₂(d₂). Because the heatmap model 800 comprises information regarding constant cross-floor attenuation (m_{cfloor}), the total signal attenuation can be expressed as m(d)=m₁(d₁)*m_{cfloor}*m₂(d₂).

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in an electronic object. In the alternative, the processor and the storage medium may reside as discrete components in a user terminal.

In one or more exemplary aspects, the functions described may be implemented in hardware, software, firmware, or any combination thereof. If implemented in software, the functions may be stored on or transmitted over as one or more instructions or code on a computer-readable storage medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, DVD, floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

1-20. (canceled)

21. An apparatus within a mobile station, the apparatus comprising:
a processor, coupled to a memory, configured to:
receive initial assistance data to assist in estimating a present position of the mobile station, wherein the initial assistance data comprises data for at least one access point (AP) associated with a first location context identifier (LCI);
determine that the estimated present position of the mobile station is within or near a poor location estimation region associated with the first LCI; and
retrieve enhanced assistance data that comprises data for at least one AP from a second LCI different from the first LCI based on the determination.

22. The apparatus recited in claim 21, wherein the poor location estimation region comprises a plurality of coordinates associated with the first LCI at which a measured horizontal dilution of precision (HDOP) exceeds a threshold value.

23. The apparatus recited in claim 21, wherein the at least one AP from the second LCI is selected among a plurality of APs from the second LCI based on the at least one AP having a shortest distance to the poor location estimation region among the plurality of APs.

24. The apparatus recited in claim 23, wherein the distance from the at least one AP to the poor location estimation region is a function of a three dimensional Euclidean distance between the AP and one or more grid points within the poor location estimation region, a routable distance between the first LCI and the second LCI, and a number of physical barriers between the AP and the one or more grid points within the poor location estimation region.

25. The apparatus recited in claim 23, wherein the plurality of APs associated with the second LCI are ranked according to average distances from the plurality of APs to each grid point within the poor location estimation region in an ascending order, and wherein the retrieved enhanced assistance data further comprises data for one or more top ranked APs among the plurality of ranked APs associated with the second LCI.

26. The apparatus recited in claim 21, wherein the at least one AP from the second LCI is selected based on the at least one AP providing coverage in the poor location estimation region associated with the first LCI.

27. The apparatus recited in claim 21, wherein the at least one AP from the second LCI is selected based on a heatmap model that represents information associated with a signal strength between the at least one AP from the second LCI and the mobile station according to one or more physical barriers that separates the at least one AP from the mobile station.

28. The apparatus recited in claim 27, wherein the signal strength information represented in the heatmap model comprises a total signal attenuation expressed according to a first signal loss from the at least one AP to the one or more physical barriers that separate the at least one AP from the mobile station, a constant attenuation across the one or more physical barriers, and a second signal loss from the one or more physical barriers to the mobile station.

29. The apparatus recited in claim 27, wherein the heatmap model is used to generate a horizontal dilution of precision (HDOP) map that defines the poor location estimation region.

30. A method improving location estimation, comprising:
receiving, at a mobile station, initial assistance data to assist in estimating a present position of the mobile station, wherein the initial assistance data comprises data for at least one access point (AP) associated with a first location context identifier (LCI);
determining, at the mobile station, that the estimated present position of the mobile station is within or near a poor location estimation region associated with the first LCI; and
retrieving, at the mobile station, enhanced assistance data that comprises data for at least one AP from a second LCI different from the first LCI based on the determination.

31. The method recited in claim 30, wherein the poor location estimation region comprises a plurality of coordinates associated with the first LCI at which a measured horizontal dilution of precision (HDOP) exceeds a threshold value.

32. The method recited in claim 30, wherein the at least one AP from the second LCI is selected among a plurality of APs from the second LCI based on the at least one AP having a shortest distance to the poor location estimation region among the plurality of APs.

33. The method recited in claim 32, wherein the distance from the at least one AP to the poor location estimation region is a function of a three dimensional Euclidean distance between the AP and one or more grid points within the poor location estimation region, a routable distance between the first LCI and the second LCI, and a number of physical barriers between the AP and the one or more grid points within the poor location estimation region.

34. The method recited in claim 32, wherein the plurality of APs associated with the second LCI are ranked according to average distances from the plurality of APs to each grid point within the poor location estimation region in an ascending order, and wherein the retrieved enhanced assistance data further comprises data for one or more top ranked APs among the plurality of ranked APs associated with the second LCI.

35. The method recited in claim 30, wherein the at least one AP from the second LCI is selected based on the at least one AP providing coverage in the poor location estimation region associated with the first LCI.

36. The method recited in claim 30, wherein the at least one AP from the second LCI is selected based on a heatmap model that represents information associated with a signal strength between the at least one AP from the second LCI and the mobile station according to one or more physical barriers that separates the at least one AP from the mobile station.

37. The method recited in claim 36, wherein the signal strength information represented in the heatmap model comprises a total signal attenuation expressed according to a first signal loss from the at least one AP to the one or more physical barriers that separate the at least one AP from the mobile station, a constant attenuation across the one or more physical barriers, and a second signal loss from the one or more physical barriers to the mobile station.

38. The method recited in claim 36, wherein the heatmap model is used to generate a horizontal dilution of precision (HDOP) map that defines the poor location estimation region.

39. A computer-readable storage medium, comprising instructions that, when executed on a mobile station, cause the mobile station to:
receive initial assistance data to assist in estimating a present position of the mobile station, wherein the initial assistance data comprises data for at least one access point (AP) associated with a first location context identifier (LCI);
determine that the estimated present position of the mobile station is within or near a poor location estimation region associated with the first LCI; and
retrieve enhanced assistance data that comprises data for at least one AP from a second LCI different from the first LCI based on the determination.

40. The computer-readable storage medium recited in claim 39,
wherein the poor location estimation region comprises a plurality of coordinates associated with the first LCI at which a measured horizontal dilution of precision (HDOP) exceeds a threshold value, and
wherein the at least one AP from the second LCI is selected based on one or more of:
the at least one AP having a shortest distance to the poor location estimation region among a plurality of APs from the second LCI,
the at least one AP providing coverage in the poor location estimation region associated with the first LCI, or
a heatmap model that represents information associated with a signal strength between the at least one AP from the second LCI and the mobile station according to one or more physical barriers that separates the at least one AP from the mobile station.
